(19) United States
(12) Patent Application Publication
(10) Pub. No.: US 2024/0165914 A1
(43) Pub. Date: May 23, 2024

(54) ARTICLE AND ARTICLE MANUFACTURING METHOD

(71) Applicant: CANON KABUSHIKI KAISHA, Tokyo (JP)

(72) Inventor: WATARU KIKUCHI, Saitama (JP)

(21) Appl. No.: 18/511,882

(22) Filed: Nov. 16, 2023

(30) Foreign Application Priority Data
Nov. 21, 2022 (JP) 2022-185913
Aug. 10, 2023 (JP) 2023-130824

(51) Int. Cl. B32B 5/12; B32B 1/08; B32B 5/02; B32B 27/12; D04C 1/02; D04C 1/06

(52) U.S. Cl. CPC B32B 5/12; B32B 1/08; B32B 5/024; B32B 27/12; D04C 1/02; D04C 1/06; B32B 2260/021; B32B 2260/046; B32B 2262/106; B32B 2307/558; B32B 2597/00; D10B 2101/12; D10B 2505/02

(57) ABSTRACT

An article includes multiple layers including carbon fibers. At least one of the multiple layers is a stone pattern braided layer.

### BACKGROUND

### Field

The present disclosure relates to an article with layers including carbon fibers and to a method of manufacturing the article.

### Description of the Related Art

Recently, carbon fiber reinforced plastics have been used as members for which weight saving, high rigidity, and impact resistance are all to be demanded. The carbon fiber reinforced plastics have been used in, for example, casings of OA devices such as a laptop and a printer, casings of optical devices such as a camera and a lens, mechanical parts, fishing rods, and parts of vehicles such as automobiles and bicycles. In an example, there is proposed a molded product using a laminate in which multiple layers including carbon fibers impregnated with resin are laminated, the carbon fibers being lightweight and having high impact resistance (see Japanese Patent Laid-Open No. 2012-32745).

However, the above-described laminate has the disadvantage that the obtained strength is different depending on a direction of the carbon fibers, and that the demanded strength and rigidity cannot be achieved.

### SUMMARY

The present disclosure provides an article including multiple layers including carbon fibers, wherein at least one of the multiple layers is a stone pattern braided layer.

The present disclosure further provides an article manufacturing method of manufacturing a tubular article in which multiple layers including carbon fibers are laminated, the method including, after forming a braided layer braided in a stone pattern, forming a braided layer braided in a twill pattern.

Further features will become apparent from the following description of exemplary embodiments with reference to the attached drawings.

### BRIEF DESCRIPTION OF THE DRAWINGS

FIG. 1 is a plan view representing an embodiment of the present disclosure.

FIGS. 2A and 2B are a plan view and a sectional view, respectively, each representing an embodiment of the present disclosure.

FIG. 3 is a perspective view representing an embodiment of the present disclosure.

FIGS. 4A and 4B represent the embodiment of the present disclosure.

FIGS. 5A and 5B are a plan view and a sectional view, respectively, each representing an embodiment of the present disclosure.

FIGS. 6A and 6B represent an embodiment of the present disclosure.

FIGS. 7A and 7B represent an embodiment of the present disclosure.

FIG. 8 represents an embodiment of the present disclosure.

FIGS. 9A and 9B are a plan view and a sectional view, respectively, each representing an embodiment of the present disclosure.

### DESCRIPTION OF THE EMBODIMENTS

### First Embodiment

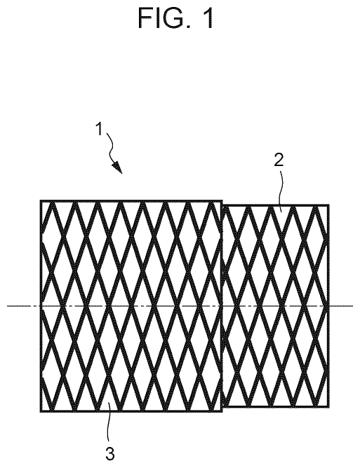

FIG. 1 is a plan view illustrating an example of a laminate according to a first embodiment of the present disclosure.

In FIG. 1, reference numeral 1 denotes the laminate in which layers including carbon fibers are laminated. Reference numeral 2 denotes a stone pattern braided layer that is a first layer, and 3 denotes a stone pattern braided layer that is a second layer.

The laminate according to this embodiment is featured in that at least one of the layers is the stone pattern braided layer. When at least one layer is the stone pattern braided layer, elasticity of the entire laminate is reduced, a deformation of the laminate is suppressed, and the carbon fibers can be more densely and uniformly laminated. Therefore, the laminate with higher strength and rigidity can be obtained. The reason is that the number of points at which the continuous carbon fibers are braided while interlacing each other becomes larger than that in the case of an ordinary twill pattern braided layer (described later) or a UD (Uni Direction) layer (a layer in which the carbon fibers are unidirectionally arrayed), and that elasticity of a braided or woven material is reduced. As a result, the laminate with higher strength and rigidity can be obtained.

While, in this embodiment, the first layer 2 and the second layer 3 are both the stone pattern braided layers, either one of the first layer 2 and the second layer 3 may be the stone pattern braided layer, and the other layer may be a layer braided or woven in a different fashion from the stone pattern braiding. In an example, either one of the first layer 2 and the second layer 3 may be the stone pattern braided layer, and the other layer may be the UD layer (the layer in which the carbon fibers are unidirectionally arrayed). Although the stone pattern braided layer is used in this embodiment, a stone pattern woven layer may be used instead.

This embodiment is described in connection with an example in which the laminate has two layers, but the present disclosure is not limited to that example. Three or more stone pattern braided layers may be laminated. Furthermore, the UD layer (the layer in which the carbon fibers are unidirectionally arrayed) may be arranged on an inner or outer side of the first layer 2.

When three or more layers are laminated, the stone pattern braided layer is preferably arranged as an inner layer (a layer other than an outermost surface layer).

Here, the stone pattern braided layer indicates a layer with a structure that the carbon fibers continuously extending in left and right oblique directions are successively braided in an up-down direction while crossing each other.

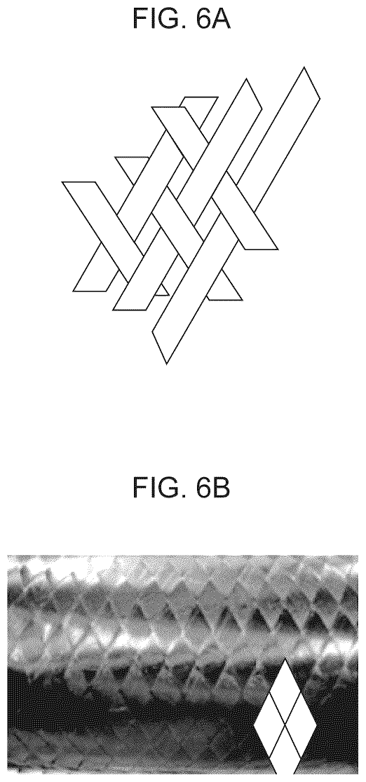

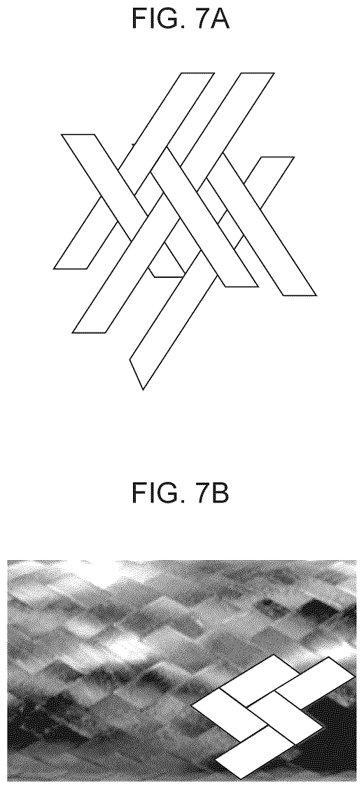

FIGS. 6A and 6B are explanatory views of the stone pattern braided layer as an example of the braided material. FIG. 6A illustrates the stone pattern braided layer in such a way of representation that intervals between the braided carbon fibers are exaggeratingly increased for easier understanding of a braiding method of the stone pattern braiding. FIG. 6B illustrates a portion of a photograph obtained by taking an image of an example of the stone pattern braided layer and represents a surface of the stone pattern braided layer of a tubular shape. FIGS. 7A and 7B are explanatory views of a twill pattern braided layer as an example of the braided material. FIG. 7A illustrates the twill pattern braided layer in such a way of representation that intervals between the braided carbon fibers are exaggeratingly increased for easier understanding of a braiding method of the twill pattern braiding. FIG. 7B illustrates a portion of a photograph obtained by taking an image of an example of the twill pattern braided layer and represents a surface of the twill pattern braided layer of a tubular shape. Although the stone pattern braiding and the twill pattern braiding are described above, the present disclosure is not limited to the stone pattern braiding and the twill pattern braiding, and any other suitable braiding method may also be used. The expressions “the stone pattern braiding” and “the twill pattern braiding” are used in this Specification, but the expressions may be replaced with “stone pattern lacing” and “twill pattern lacing”, respectively. Stone pattern weaving is also known as a similar term to the stone pattern braiding.

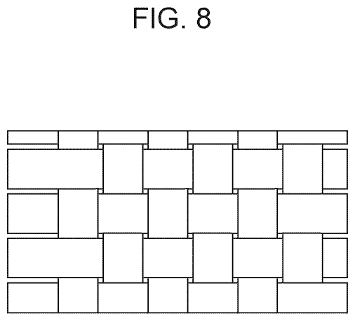

The stone pattern weaving is plain weaving usually called in relation to fiber cloth, made by using a weaving machine, in which a woven pattern is formed with continuous fibers overlapping each other in vertical and horizontal directions. FIG. 8 is an explanatory view of the stone pattern weaving (plain weaving) as an example of weaving of fabric and illustrates the stone pattern weaving in such a way of representation that intervals between the woven carbon fibers are exaggeratingly increased for easier understanding of a weaving method. The weaving method is not limited to the stone pattern weaving (plain weaving) and may be twill weaving or another weaving method. According to the stone pattern weaving, however, an angle formed between fibers crossing in the fabric made by using the weaving machine is necessarily 90°. On the other hand, according to the stone pattern braiding, an angle formed between fibers is not limited to 90° and can be evenly set to a desired angle, and the braided material has a tubular shape as another feature. The tubular material formed by the stone pattern braiding can also be cut open into a sheet.

The carbon fibers are preferably impregnated with resin in advance. The resin to be impregnated is not limited to particular one, but CFRTP (Carbon Fiber Reinforced Thermo-Plastics), one of thermoplastic resins, is preferably used.

Thus, the type of the resin is not limited to a particular one. As for thermoplastic resins, PA, PC, PMMA, PEEK, PPS, PP, and so on can be used. As for thermosetting resins, epoxy resin, phenol resin, unsaturated polyester resin, vinyl ester resin, and so on can be used.

A carbon fiber manufacturing method may include, for example, the steps of sandwiching a continuous fiber sheet material and a resin film between heating rolls or the likes, forming an integrated prepreg sheet, and cutting the prepreg sheet into tapes. Another example of the carbon fiber manufacturing method may include the steps of electrostatically attaching resin powder to a continuous fiber sheet material, forming a prepreg sheet by heating the fiber sheet material, and cutting the prepreg sheet into tapes.

Alternatively, fibers obtained by interlacing continuous fibers and thermoplastic resin fibers may also be used after shaping the fibers into the form of a tape. Here, the term “prepreg” indicates the carbon fibers impregnated with the resin in advance.

As another carbon fiber manufacturing method, liquid resin may be coated over a continuous fiber.

On that occasion, a sizing agent may be used to increase affinity between the continuous fibers and the resin.

Furthermore, on that occasion, a bundle of the continuous fibers is desirably made open to be flat.

While the laminate of the sheet shape is described in this embodiment, the shape of the laminate is not limited to the sheet. The laminate may have, for example, a tubular shape.

Molded products being superior in strength and rigidity and having various shapes can be obtained by using the laminate according to this embodiment. The molded products of various shapes can be each obtained, for example, by placing the laminate according to this embodiment in a mold of the desired shape, and by melting and solidifying the resin impregnated to the carbon fibers. The resin may be solidified by heating with a heater, for example, and pressing with an autoclave, for example.

A covering film layer may be formed as an outermost layer of the molded product. A thickness of the covering film layer is desirably 20 μm or more and 200 μm or less. The reason is as follows. If the thickness is less than 20 μm, a uniform covering film cannot be formed on the surface of the molded product. If the thickness is more than 200 μm, man-hours required in a film-forming step to obtain the desired thickness of the covering film increase, and the cost increases. In the latter case, there is also a possibility that the intended purpose, namely weight saving, cannot be achieved. A method of forming the covering film is not limited to a particular one and may be painting or coating. A material of the covering film is not limited to a particular one and may be, for example, epoxy resin, urethane resin, fluororesin, polyester resin, silicone resin, acrylic resin, or urethan acrylic resin. An additive for giving a desired function, such as a pigment or fine particles, may be mixed into the material of the covering film. The covering film layer may be made up of multiple layers including, for example, a binder layer and a functional layer.

An article obtained by this embodiment is superior in strength and rigidity because of using the laminate and the molded product with higher strength and rigidity. The article according to this embodiment can be used as, for example, casings of OA devices such a laptop and a printer, and casings of optical devices such as a camera and a lens. The article according to this embodiment can be further used in mechanical parts, fishing rods, automobiles, bicycles, rail cars, ships, aircrafts, and so on, including, for example, exterior materials, interior materials, structural materials (such as a body shell, a vehicle body, and an aircraft fuselage), and cushion materials. Among the above-mentioned examples, the automobile parts include automobile exterior materials, automobile interior materials, automobile structural materials, automobile cushion materials, engine room parts, and so on.

Other application examples of the article according to this embodiment include interior materials, exterior materials, and structural materials of buildings, furniture, and so on. In more detail, the article according to this embodiment may be used as, for example, door covering materials, door structural materials, covering materials and structural materials for various types of furniture (such as a desk, a chair, a shelf, and a chest), modular bathrooms, and septic tanks. Still other examples may include a package, a container (such as a tray), a protection member, and a partition member. In addition, the article according to this embodiment may be further used as molded products for casings (housings), structural members, and so on of home appliances (such as a flat screen TV, a refrigerator, a washing machine, a vacuum cleaner, a mobile phone, a handheld game console, and a laptop).

### Second Embodiment

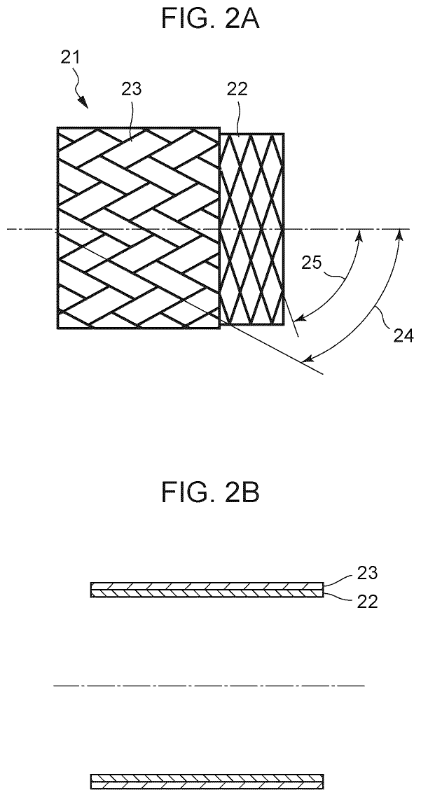

FIGS. 2A and 2B are a plan view and a sectional view, respectively, each representing a second embodiment of the present disclosure.

In FIGS. 2A and 2B, reference numeral 21 denotes a tubular laminate in which carbon fiber braided layers are laminated. Reference numeral 22 denotes a stone pattern braided layer as a first layer. Reference numeral 23 denotes a twill pattern braided layer as a second layer. Reference numeral 24 denotes a braiding angle of the second layer, and 25 denotes a braiding angle of the first layer. This embodiment is different from the first embodiment in that the tubular laminate is used in this embodiment. Description of the same components as those in the first embodiment is omitted in some cases.

This embodiment represents the laminate in which the stone pattern braided layer 22 is arranged as the first layer and the twill pattern braided layer 23 is arranged as the second layer.

If a thin-wall tubular structural body is compressed in a tube axial direction, the tubular structural body is deformed to expand outward and is finally buckled and broken. Here, the term “tube axial direction” indicates a direction in which a tube center line extends.

To increase the strength of the tubular laminate 21 including the braided layers, the braiding angle 24 of the outer braided layer needs to be reduced for transmitting a force to the carbon fibers present in an outward expanding direction.

To maintain the tubular shape, however, a force needs to be transmitted to the carbon fibers in a tube circumferential direction. Therefore, the braiding angle 25 of the inner braided layer needs to be increased. The tube circumferential direction indicates a direction along an outer or inner circumference of the tubular laminate.

In the laminate according to this embodiment, since the stone pattern braided layer is arranged as a layer on an inner side than the twill pattern braided layer, the braiding angle 24 of the outer braided layer can be made smaller than the braiding angle 25 of the inner braided layer. Accordingly, the elasticity of the entire laminate is reduced, a deformation of the laminate is suppressed, and the carbon fibers can be more densely and uniformly laminated. Hence the laminate with higher strength and rigidity can be obtained.

As a result, the strength of the laminate and an article using the laminate can be increased.

Here, the term “braiding angle” indicates an angle formed between the tube axial direction of the tubular laminate and the braided carbon fibers.

While this embodiment represents an example in which the laminate is the two-layer laminate, the present disclosure is not limited to that example. Two or more stone pattern braided layers may be laminated, or two or more twill pattern braided layers may be laminated. The UD layer (the layer in which the carbon fibers are unidirectionally arrayed) may be arranged on an inner or outer side of the first layer 22. The UD layer (the layer in which the carbon fibers are unidirectionally arrayed) may be arranged on an inner or outer side of the second layer 23.

Preferably, a braider is used to form the carbon fiber braided layer.

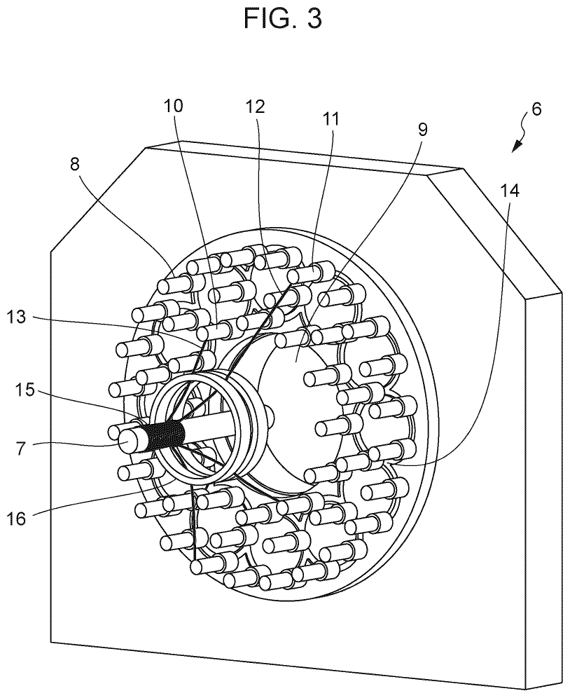

FIG. 3 is a perspective view of the braider.

In FIG. 3, reference numeral 6 denotes the braider, 7 denotes a mandrel, 8 denotes an annular frame, 9 denotes a through-hole, 10 and 11 denote carriers, 12 and 13 denote the carbon fibers, 14 denotes a figure eight track, 15 denotes a braided layer, and 16 denotes a guide ring.

The braided layer in this embodiment is formed over the mandrel 7, also called an arbor, by the braider 6 illustrated in FIG. 3.

The braider 6 includes the annular frame 8, and the mandrel 7 is inserted through the through-hole 9 of the annular frame 8.

The multiple carriers 10 and 11 for supplying the carbon fibers 12 and 13, respectively, are disposed on the annular frame 8.

Bobbins (not illustrated) are assembled in the carriers 10 and 11 in a one-to-one relation, and the carbon fibers 12 and 13 are previously wound in the bobbins.

The carbon fibers 12 and 13 previously wound in the bobbins are let out from the carriers 10 and 11, respectively, and are guided toward the mandrel 7 while the tape-shaped carbon fibers 12 and 13 are each bent by the guide ring 16 toward a direction corresponding to the desired braiding angle.

In this connection, the carriers 10 and 11 include mechanisms (not illustrated) for generating tension, for example, a spring force, acting on the carbon fibers 12 and 13 to be tightly wound around the mandrel 7.

The carriers 10 and 11 are moved along the figure eight track 14 formed on the annular frame 8. At that time, a moving direction of the carriers 10 which are one half of the total carriers is clockwise, and a moving direction of the carriers 11 which are the other one half of the total carriers is counterclockwise. Thus, the moving directions of the carriers 10 and 11 are opposite to each other.

With the above-described movements, the carbon fibers 12 and 13 are caused to cross each other, and the braided layer 15 made up of the crossing carbon fibers 12 and 13 is formed over the mandrel 7.

On that occasion, supposing that a certain carrier is moved clockwise along the figure eight track, the twill pattern braided layer is obtained by moving the clockwise carrier to pass a crossing point of the figure eight track after passage of two counterclockwise carriers, and the stone pattern braided layer is obtained by moving the clockwise carrier to pass the track crossing point after passage of one counterclockwise carrier.

If the twill pattern braided layer is formed in direct contact with the mandrel 7, there is a possibility that, because the twill pattern braided layer tends to easily move away from the mandrel 7 due to its elasticity, it may move away from the mandrel 7 during transport to a next step or during impregnation molding in the next step and the carbon fibers may slip out from the mandrel. In consideration of the above point, the stone pattern braided layer 22 is arranged in a layer inner than the twill pattern braided layer (namely, in a layer closer to the mandrel 7). With such an arrangement, the carbon fibers can be avoided from moving away from the mandrel 7, and reduction in strength and rigidity of the finally obtained tubular laminate 21 can be prevented. Thus, it is more desired that the stone pattern braided layer be formed in direct contact with the mandrel 7.

Here, in the stone pattern braided layer 22, the continuous carbon fiber reinforced resins are successively braided in the up-down direction while crossing each other, and the number of points at which the carbon fibers are braided is larger than that in the twill pattern braided layer. Accordingly, the elasticity of the braided material is reduced.

As a result, the twill pattern braided layer 23 braided in an upper layer (outer layer) than the stone pattern braided layer 22 can be suppressed from shrinking to move away from the mandrel 7 and from increasing its diameter. Thus, the twill pattern braided layer 23 can be prevented from moving away from the mandrel 7. The twill pattern braided layer is more preferably formed on the stone pattern braided layer 22 in direct contact with it, but the UD layer (layer of unidirectionally carbon fiber reinforced resin) may be arranged on an inner or outer side of the stone pattern braided layer 22.

The reason is that the UD layer has no elasticity in nature and substantially does not cause the disadvantage of moving-away from the mandrel.

Furthermore, multiple stone pattern braided layers 22 may be laminated.

Preferably, the stone pattern braided layer, the twill pattern braided layer, and the UD layer are formed in order from an inner side toward an outer side. With such an arrangement, the elasticity of the entire laminate is reduced, a deformation of the laminate is suppressed, and the carbon fibers can be more densely and uniformly laminated. Hence the laminate with higher strength and rigidity can be obtained.

While the number of the carriers is 48 in FIG. 3, it is not limited to that value.

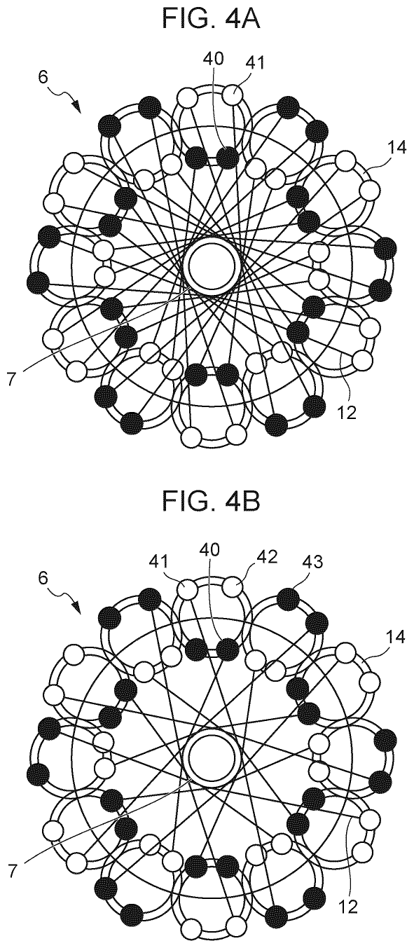

FIGS. 4A and 4B are schematic views illustrating relationships between the carriers and the carbon fibers.

In FIGS. 4A and 4B, reference numeral 40 denotes the clockwise carrier, 41 denotes the counterclockwise carrier, and 42 and 43 denote the carriers that are not in use.

FIG. 4A is the schematic view illustrating the case in which the carriers of the braider 6 are all used in the braiding. The same elements as those in FIG. 3 are denoted by the same reference numerals, and description of those elements is omitted in some cases.

In general, the braider 6 includes the clockwise carriers 40 and the counterclockwise carriers 41, and the carbon fibers 12 are let out from those carriers to make braiding (to form the braided layer) successively while the carriers are circulating along the figure eight track 14.

On that occasion, for example, during a period in which two counterclockwise carriers 41 pass an outer side of the figure eight track 14 at certain timing, the clockwise carrier 40 passes an inner side of the figure eight track 14.

With the above-described movements of the carriers, the twill pattern braided layer can be formed in the pattern in which the carbon fibers 12 cross each other in units of two fibers.

FIG. 4B is the schematic view illustrating the case in which half of all the carriers of the braider 6 are used in the braiding.

On that occasion, for example, during a period in which one counterclockwise carrier 41 passes the outer side of the figure eight track at certain timing, the clockwise carrier 40 passes the inner side of the figure eight track.

With the above-described movements of the carriers, the stone pattern braided layer can be formed in the pattern in which the carbon fibers 12 cross each other in the up-down direction in units of one fiber.

On that occasion, preferably, the carbon fibers 12 are prepared as prepreg tapes, and widths of the tape-shaped carbon fibers forming the stone pattern braided layer and the twill pattern braided layer are the same.

During the braiding, a withdrawing speed of the mandrel 7 is adjusted such that the tapes are braided to be aligned.

As a result, the braiding angle of the stone pattern braided layer on the inner layer side can be increased, and the braiding angle of the twill pattern braided layer can be reduced.

The carriers 42 and 43 not in use may be held in a state in which the bobbins are not attached and the carbon fibers 12 are not supplied. Alternatively, the carbon fibers 12 may be fixed to the carriers 42 and 43 not in use by a suitable fashion (not illustrated) such that the carbon fibers are not supplied.

As a result, a tubular laminate made of the carbon fibers with high strength in the tube axial direction can be manufactured while the cost required for preparing the tape-shaped carbon fibers of the different widths is suppressed and man-hours required for winding the tape-shaped carbon fibers of the different widths on the bobbins are reduced.

A molded product with high strength and rigidity can be obtained by using the laminate according to this embodiment. Molded products of various shapes can be each obtained by placing the tubular laminate according to this embodiment in a mold corresponding to the desired finished shape together with the mandrel or alone, and by melting and solidifying the resin impregnated to the carbon fibers. The resin may be solidified by heating with a heater, for example, and pressing with an autoclave, for example. When the resin is sintered for solidification, the shape of the molded product may be defined, as required, by using another mold to press the resin from the outer side of the mandrel.

The article may be manufactured by forming a covering film layer on a surface of the molded product. In other words, a covering film layer may be formed as an outermost layer of the molded product. A thickness of the covering film layer is desirably 20 μm or more and 200 μm or less. The reason is as follows. If the thickness is less than 20 μm, a uniform covering film cannot be formed on the surface of the molded product. If the thickness is more than 200 μm, man-hours required in a film-forming step to obtain the desired thickness of the covering film increase, and the cost increases. In the latter case, there is also a possibility that the intended purpose, namely weight saving, cannot be achieved. A method of forming the covering film is not limited to a particular one and may be painting or coating. A material of the covering film is not limited to a particular one and may be, for example, epoxy resin, urethane resin, fluororesin, polyester resin, silicone resin, acrylic resin, or urethan acrylic resin. An additive for giving a desired function, such as a pigment or fine particles, may be mixed into the material of the covering film. The covering film layer may be made up of multiple layers including, for example, a binder layer and a functional layer.

The article obtained with this embodiment is superior in strength and rigidity because of using the laminate and the molded product with higher strength and rigidity. The article according to this embodiment preferably has the tubular shape and can be used as, for example, casings of optical devices such as a camera and a lens. The article according to this embodiment can be further used in mechanical parts, fishing rods, automobiles, bicycles, rail cars, ships, aircrafts, and so on, including, for example, exterior materials, interior materials, structural materials (such as a body shell, a vehicle body, and an aircraft fuselage), and cushion materials. Among the above-mentioned examples, the automobile parts include automobile exterior materials, automobile interior materials, automobile structural materials, automobile cushion materials, engine room parts, and so on.

Other application examples of the article according to this embodiment include interior materials, exterior materials, and structural materials of buildings, furniture, and so on. In more detail, the article according to this embodiment may be used as, for example, door covering materials, door structural materials, covering materials and structural materials for various types of furniture (such as a desk, a chair, a shelf, and a chest), modular bathrooms, and septic tanks. Still other examples may include a package, a container (such as a tray), a protection member, and a partition member. In addition, the article according to this embodiment may be further used as molded products for casings (housings), structural members, and so on of home appliances (such as a flat screen TV, a refrigerator, a washing machine, a vacuum cleaner, a mobile phone, a handheld game console, and a laptop).

### Third Embodiment

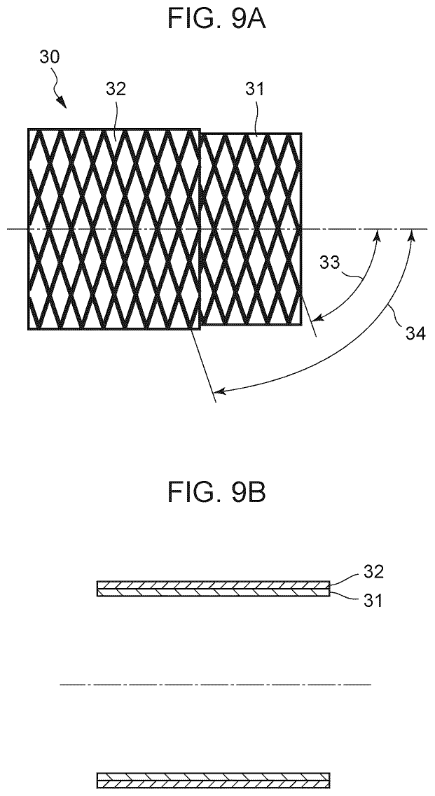

FIGS. 9A and 9B are a plan view and a sectional view, respectively, each representing a third embodiment of the present disclosure.

In FIGS. 9A and 9B, reference numeral 30 denotes a tubular laminate in which carbon fiber braided layers are laminated. Reference numeral 31 denotes a stone pattern braided layer that is a first layer, and 32 denotes a stone pattern braided layer that is a second layer. Reference numeral 33 denotes the braiding angle of the first layer, and 34 denotes the braiding angle of the second layer. This embodiment is different from the first embodiment in that the tubular laminate is used in this embodiment. Description of the same components as those in the first embodiment is omitted in some cases.

This embodiment represents the tubular laminate in which the stone pattern braided layer 31 is arranged as the first layer and the stone pattern braided layer 32 is arranged as the second layer.

The laminate according to this embodiment is featured in that at least one layer is the stone pattern braided layer. When at least one layer is the stone pattern braided layer, elasticity of the entire laminate is reduced, a deformation of the laminate is suppressed, and the carbon fibers can be more densely and uniformly laminated. Therefore, the laminate with higher strength and rigidity can be obtained. The reason is that the number of points at which the continuous carbon fibers are braided while interlacing each other becomes larger than that in the case of the ordinary twill pattern braiding (described later) or the UD (Uni Direction) layer (the layer in which the carbon fibers are unidirectionally arrayed), and that elasticity of a braided or woven material is reduced. As a result, the laminate with higher strength and rigidity can be obtained.

On that occasion, the braiding angle of the stone pattern braided layer is preferably 45° or more and particularly preferably 54° or more.

If the braiding angle is less than 45°, the rigidity in a direction perpendicular to the tube axial direction becomes weaker than that in the tube axial direction, and there is a possibility that dimension accuracy may deteriorate to such as extent as causing a warpage particularly relative to the tube axial direction. From the viewpoint of further increasing the dimension accuracy, the braiding angle is preferably set to be 54° or more.

Here, the term “tube axial direction” indicates a direction in which a tube center line extends.

While, in this embodiment, the first layer 31 and the second layer 32 are both the stone pattern braided layers, either one of the first layer 31 and the second layer 32 may be the stone pattern braided layer, and the other layer may be a braided or woven layer formed in a different manner from the stone pattern braiding. In an example, either one of the first layer 31 and the second layer 32 may be the stone pattern braided layer, and the other layer may be the UD layer (the layer in which the carbon fibers are unidirectionally arrayed).

While this embodiment is described in connection with an example in which the laminate has two layers, the present disclosure is not limited to that example. Three or more stone pattern braided layers may be laminated. Furthermore, the UD layer (the layer in which the carbon fibers are unidirectionally arrayed) may be arranged on an inner or outer side of the first layer 31.

When three or more layers are laminated, the stone pattern braided layer is preferably arranged as an inner layer (a layer other than an outermost surface layer).

Here, the term “braiding angle” indicates an angle formed between the tube axial direction of the tubular laminate and the braided carbon fibers. While this embodiment represents an example in which the laminate is the two-layer laminate, the present disclosure is not limited to that example. Two or more stone pattern braided layers may be laminated, or two or more twill pattern braided layers may be laminated. The UD layer (the layer in which the carbon fibers are unidirectionally arrayed) may be arranged on an inner or outer side of the first layer 31. The UD layer (the layer in which the carbon fibers are unidirectionally arrayed) may be arranged on an inner or outer side of the second layer 32.

Preferably, a braider is used to form the carbon fiber braided layer.

FIG. 3 is a perspective view of the braider.

In FIG. 3, reference numeral 6 denotes the braider, 7 denotes a mandrel, 8 denotes an annular frame, 9 denotes a through-hole, 10 and 11 denote carriers, 12 and 13 denote the carbon fibers, 14 denotes a figure eight track, 15 denotes a braided layer, and 16 denotes a guide ring.

The braided layer in this embodiment is formed over the mandrel 7, also called an arbor, by the braider 6 illustrated in FIG. 3.

The braider 6 includes the annular frame 8, and the mandrel 7 is inserted through the through-hole 9 of the annular frame 8.

The multiple carriers 10 and 11 for supplying the carbon fibers 12 and 13, respectively, are disposed on the annular frame 8.

Bobbins (not illustrated) are assembled in the carriers 10 and 11 in a one-to-one relation, and the carbon fibers 12 and 13 are previously wound in the bobbins.

The carbon fibers 12 and 13 previously wound in the bobbins are let out from the carriers 10 and 11, respectively, and are guided toward the mandrel 7 while the tape-shaped carbon fibers 12 and 13 are each bent by the guide ring 16 toward a direction corresponding to the desired braiding angle.

In this connection, the carriers 10 and 11 include mechanisms (not illustrated) for generating tension, for example, a spring force, acting on the carbon fibers 12 and 13 to be tightly wound over the mandrel 7.

The carriers 10 and 11 are moved along the figure eight track 14 formed on the annular frame 8. At that time, a moving direction of the carriers 10 which are one half of the total carriers is clockwise, and a moving direction of the carriers 11 which are the other one half of the total carriers is counterclockwise. Thus, the moving directions of the carriers 10 and 11 are opposite to each other.

With the above-described movements, the carbon fibers 12 and 13 are caused to cross each other, and the braided layer 15 made up of the crossing carbon fibers 12 and 13 are formed over the mandrel 7.

On that occasion, supposing that a certain carrier is moved clockwise along the figure eight track, the twill pattern braided layer is obtained by moving the clockwise carrier to pass a crossing point of the figure eight track after passage of two counterclockwise carriers, and the stone pattern braided layer is obtained by moving the clockwise carrier to pass the track crossing point after passage of one counterclockwise carrier.

While the number of the carriers is 48 in FIG. 3, it is not limited to that value.

Molded products of various shapes can be each obtained by placing the tubular laminate according to this embodiment in a mold corresponding to the desired finished shape together with the mandrel or alone, and by melting and solidifying the resin impregnated to the carbon fibers. The resin may be solidified by heating with a heater, for example, and pressing with an autoclave, for example. When the resin is sintered for solidification, the shape of the molded product may be defined, as required, by using another mold to press the resin from the outer side of the mandrel.

An article may be manufactured by forming a covering film layer on a surface of the molded product. In other words, a covering film layer may be formed as an outermost layer of the molded product. A thickness of the covering film layer is desirably 20 μm or more and 200 μm or less. The reason is as follows. If the thickness is less than 20 μm, a uniform covering film cannot be formed on the surface of the molded product. If the thickness is more than 200 μm, man-hours required in a film-forming step to obtain the desired thickness of the covering film increase, and the cost increases. In the latter case, there is also a possibility that the intended purpose, namely weight saving, cannot be achieved. A method of forming the covering film is not limited to a particular one and may be painting or coating. A material of the covering film is not limited to a particular one and may be, for example, epoxy resin, urethane resin, fluororesin, polyester resin, silicone resin, acrylic resin, or urethan acrylic resin. An additive for giving a desired function, such as a pigment or fine particles, may be mixed into the material of the covering film. The covering film layer may be made up of multiple layers including, for example, a binder layer and a functional layer.

The article according to this embodiment is superior in strength and rigidity because of using the laminate and the molded product with higher strength and rigidity. The article according to this embodiment preferably has the tubular shape and can be used as, for example, casings of optical devices such as a camera and a lens. The article according to this embodiment can be further used in mechanical parts, fishing rods, automobiles, bicycles, rail cars, ships, aircrafts, and so on, including, for example, exterior materials, interior materials, structural materials (such as a body shell, a vehicle body, and an aircraft fuselage), and cushion materials. Among the above-mentioned examples, the automobile parts include automobile exterior materials, automobile interior materials, automobile structural materials, automobile cushion materials, engine room parts, and so on.

Other application examples of the article according to this embodiment include interior materials, exterior materials, and structural materials of buildings, furniture, and so on. In more detail, the article according to this embodiment may be used as, for example, door covering materials, door structural materials, covering materials and structural materials for various types of furniture (such as a desk, a chair, a shelf, and a chest), modular bathrooms, and septic tanks. Still other examples may include a package, a container (such as a tray), a protection member, and a partition member. In addition, the article according to this embodiment may be further used as molded products for casings (housings), structural members, and so on of home appliances (such as a flat screen TV, a refrigerator, a washing machine, a vacuum cleaner, a mobile phone, a handheld game console, and a laptop).

### Fourth Embodiment

An article according to a fourth embodiment is a tubular member forming, for example, a lens barrel component in an optical device such as an interchangeable lens of a camera, including a lens hood, a focus ring, and a lens barrel structural member, for example, and is constituted as a tubular molded product. Here, the lens hood is a shading component for shielding unwanted light other than shooting light not to enter a shooting optical system and is detachably attached to a fore end of an optical device (image capturing device) such as a camera. Furthermore, other lens barrel components, such as outer and inner tubes of a lens barrel and the focus ring, can be regarded as the lens barrel components that constitute the lens barrel structural members for holding or adjusting optical elements such as a lens and a mirror.

At least one end portion of the article is covered with a resin component formed as a coating portion. The coating portion can be formed by, for example, insert injection molding of thermoplastic resin. In an example, the coating portion is formed to be integrated with a molded product by inserting the molded product into a mold for the injection molding and by injection-molding the thermoplastic resin containing fibers.

For the purpose of, for example, obtaining the sufficient strength when the article is used as a fixing portion or a detachably attached portion of the lens barrel component, the coating portion is preferably made of, for example, the thermoplastic resin containing fibers. The thermoplastic resin forming the coating portion may be, for example, polycarbonate. When the polycarbonate is used, the lens barrel component can be obtained in which, for example, the attached portion formed by the coating portion has increased toughness due to high impact resistance of the polycarbonate itself.

By forming the coating portion at the end portion of the molded product, for example, it is possible to dispose, on the lens barrel component, a ring component or the like which is to be used as the fixing portion or the detachably attached portion and which cannot be formed in a process of from braiding to solidifying steps in manufacturing of the molded product.

The coating portion may be molded to cover the circumference of one end portion of the molded product, and a flange circumferentially protruding toward the inner side may be formed inside the end portion. When the molded product is the lens barrel structural member, the flange is used as, for example, a support for the optical element or the focus ring. When the molded product is, for example, the lens hood that is detachably attached to a main body of the shooting optical system, the resin component formed as the coating portion can be utilized as a portion of a mechanism for detachably attaching the lens hood.

### Examples

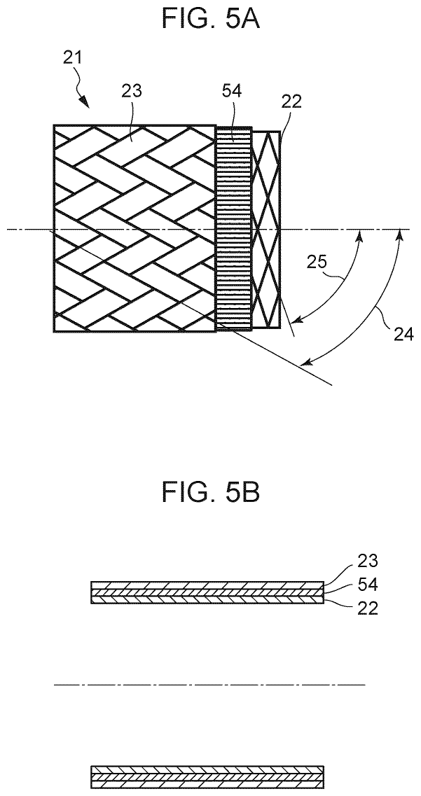

A configuration of a first example will be described below with reference to FIGS. 5A and 5B. The same components as those in the second embodiment are denoted by the same reference numerals, and description of those components is omitted in some cases.

In FIGS. 5A and 5B, reference numeral 54 denotes a UD layer.

An inner diameter of the tubular laminate 21 was set to ϕ170.

Two braided layers were arranged in the tubular laminate 21. More specifically, the stone pattern braided layer 22 was arranged on an inner side, the twill pattern braided layer 23 was arranged on an outer side, and the UD layer 54 made up of the carbon fibers arrayed in the tube axial direction was arranged between both the braided layers.

A braider operating in a general fashion was used here. The braider used was of the type basically operating as follows. For example, during a period in which two carriers moving counterclockwise at certain timing pass the outer side of the figure eight track, one carrier moving clockwise passes the inner side of the figure eight track.

In the braider used, the number of carriers was 64.

The stone pattern braided layer 22 was formed over the mandrel by using only 32 carriers, namely a half of all the carriers of the braider.

Then, on the stone pattern braided layer 22, the UD layer 54 was arranged in such a direction that the carbon fibers were arrayed in the tube axial direction. After that, the twill pattern braided layer 23 was formed.

The twill pattern braided layer 23 was formed by using all the 64 carriers of the braider.

On that occasion, the braiding angle 24 of the stone pattern braided layer 22 was 64°, and the braiding angle 25 of the twill pattern braided layer 23 was 30°.

After that, the tubular laminate 21 with multiple layers including the carbon fibers was obtained by molding the tubular laminate while the resin for the carbon fibers were impregnated between the carbon fibers by an impregnation molding method (not illustrated).

On that occasion, the tape-shaped carbon fibers were used, and widths of the carbon fibers used for the stone pattern braided layer 22 and the twill pattern braided layer 23 were set to the same value, namely 14.5 mm.

Because the tolerance of the width of the tape-shaped carbon fibers supplied at that time was +1 mm, tape widths varying in a range within +1 mm were regarded as the same width.

A VF (fiber volume content) value of the carbon fibers used in the braiding was set to 50%. Because of the necessity of giving flexibility to the tape-shaped carbon fibers during the braiding, a semi-impregnation state was held, and a density in the semi-impregnation state was set to fall in a range of 50% to 60%.

The resin to be impregnated was given as PC (polycarbonate) with viscosity average molecular weight of 20000.

The tape-shaped carbon fibers were fabricated by sandwiching a carbon fiber sheet material in an opened flat form and a PC film between heating rolls, for example, by integrating the sheet material and the PC film into a prepreg sheet, and by cutting the prepreg sheet into tapes.

A VF (fiber volume content) value of a UD sheet forming the UD layer 54 was also set to 50%. Because of the necessity of giving flexibility to the UD sheet during winding, a semi-impregnation state was held, and a density in the semi-impregnation state was set to fall in a range of 50% to 60%.

The resin to be impregnated into the UD sheet was given as PC with viscosity average molecular weight of 20000.

Furthermore, a continuous carbon fiber sheet material in an opened flat form and a PC film were sandwiched between heating rolls, for example, and were integrated into a prepreg sheet.

A configuration of a second example will be described below with reference to FIGS. 9A and 9B. The same components as those in the above-described first example are denoted by the same reference numerals, and description of those components is omitted in some cases.

In FIGS. 9A and 9B, an inner diameter of the tubular laminate 30 was set to ϕ170.

Two braided layers were arranged in the tubular laminate 30, and the stone pattern braided layer was formed as each of the two layers.

A braider operating in a general fashion was used here. The braider used was of the type basically operating as follows. For example, during a period in which two carriers moving clockwise at certain timing pass the outer side of the figure eight track, one carrier moving counterclockwise passes the inner side of the figure eight track.

In the braider used, the number of carriers was 64.

The stone pattern braided layers 31 and 32 were each formed over the mandrel by using only 32 carriers, namely a half of all the carriers of the braider.

The braided layers were each formed as the stone pattern braided layer by using the tape-shaped carbon fibers.

On that occasion, the braiding angles 33 and 34 of the inner and outer layers were changed as indicated in Table 1.

A warpage caused depending on difference in the braiding angle relative to the tube axial direction was evaluated by measuring roundness of the tubular laminate in a region near the center of a laminate length in the tube axial direction.

The braiding angle was changed by a method of changing the width of the tape-shaped carbon fibers.

After that, the tubular laminate 30 with multiple layers including the carbon fibers was obtained by molding the tubular laminate while the resin for the carbon fibers were impregnated between the carbon fibers by an impregnation molding method (not illustrated).

On that occasion, a VF (fiber volume content) value of the tape-shaped carbon fibers used in the braiding was set to 50%. Because of the necessity of giving flexibility to the tape-shaped carbon fibers during the braiding, a semi-impregnation state was held, and a density in the semi-impregnation state was set to fall in a range of 50% to 60%.

The resin to be impregnated was given as PC with viscosity average molecular weight of 20000.

The tape-shaped carbon fibers were fabricated by sandwiching a carbon fiber sheet material in an opened flat form and a PC film between heating rolls, for example, by integrating the sheet material and the PC film into a prepreg sheet, and by cutting the prepreg sheet into tapes.

A theoretical thickness per tape layer was set to 0.12 mm.

TABLE 1

| | | | |
|---|---|---|---|
| Braiding Angles 33 and 34 [°] | 45 | 54 | 60 |
| Tape Width [mm] | 24 | 20 | 17 |
| Roundness [μm] | 2400 | 960 | 880 |

The laminate and the molded product with the desired strength and rigidity can be obtained.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-185913, filed Nov. 21, 2022, and No. 2023-130824, filed Aug. 10, 2023, which are hereby incorporated by reference herein in their entirety.

What is claimed is:

1. An article comprising:
multiple layers including carbon fibers,
wherein at least one of the multiple layers is a stone pattern braided layer.

2. The article according to claim 1, wherein at least one of the multiple layers is a twill pattern braided layer.

3. The article according to claim 1, wherein at least one of the multiple layers is a Uni Direction (UD) layer.

4. The article according to claim 3, wherein, in the multiple layers, the twill pattern braided layer is formed on the stone pattern braided layer, and the UD layer is formed on the twill pattern braided layer.

5. The article according to claim 1, wherein the multiple layers include resin, and the resin is polycarbonate.

6. The article according to claim 1, wherein at least one of the multiple layers is made of Carbon Fiber Reinforced Thermo-Plastics (CFRTP).

7. The article according to claim 1, wherein a covering film layer is formed as an outermost layer.

8. The article according to claim 1, wherein the article has a tubular shape.

9. The article according to claim 8, wherein a braiding angle of the stone pattern braided layer is 54° or more.

10. The article according to claim 8, wherein, in the multiple layers, the stone pattern braided layer, the twill pattern braided layer, and the UD layer are formed in order from an inner side toward an outer side.

11. A device comprising, as a casing, an article comprising:
multiple layers including carbon fibers,
wherein at least one of the multiple layers is a stone pattern braided layer,
the device including parts covered with the casing.

12. An optical device comprising an optical element and a structural member arranged to hold the optical element, wherein the optical device includes, as the structural member, an article comprising:
multiple layers including carbon fibers,
wherein at least one of the multiple layers is a stone pattern braided layer.

13. An article manufacturing method of manufacturing an article including a tubular laminate in which multiple layers including carbon fibers are laminated, the method comprising:
after forming a braided layer braided in a stone pattern, forming a braided layer braided in a twill pattern.

14. The article manufacturing method according to claim 13, wherein the braided layer braided in the twill pattern is formed in contact with the braided layer braided in the stone pattern.

15. The article manufacturing method according to claim 13, wherein the braided layer braided in the stone pattern is formed in contact with a mandrel.
